(19) United States
(12) Patent Application Publication
(10) Pub. No.: US 2003/0217094 A1
(43) Pub. Date: Nov. 20, 2003

(54) Correlation framework

(76) Inventors: Anthony Dean Andrews, Sammamish, WA (US); Johannes Klein, Sammamish, WA (US); Bimal Kumar Mehta, Redmond, WA (US); Satish Ramchandra Thatte, Redmond, WA (US)

Correspondence Address: AMIN & TUROCY, LLP, 24TH FLOOR, NATIONAL CITY CENTER, 1900 EAST NINTH STREET, CLEVELAND, OH, 44114, US

(21) Appl. No.: 10/147,592

(22) Filed: May 17, 2002

(51) Int. Cl. G06F 15/16

(52) U.S. Cl. 709/201; 709/205

(57) ABSTRACT

A system and method facilitating business process(es) employing a correlation set is provided. The invention includes a system for sending message(s) having a data retrieval component and a service component. The data retrieval provides an output to the service component based on a schema and a business process type. The service component generates a message having a correlation set based on the output of the data retrieval component. To initiate a business process, the service component generates an activation message and the correlation set, the correlation set uniquely identifying the business process.

Also provided is a system for receiving message(s) having a message identification component and a message routing component. The message identification component receives a message and identifies a schema associated with the message, the schema and the message providing information associated with a correlation set. The message routing component routes the message to instance data associated with the message based, at least in part, upon the correlation set.

### TECHNICAL FIELD

The present invention relates generally to business process system(s), and more particularly system(s) employing a correlation set to facilitate business process(es).

### BACKGROUND OF THE INVENTION

Workflow applications are related to businesses, governments, and other organizations where information and work product flows between various persons or departments. Workflow generally is the flow of information and control in such organizations. In a business setting, workflow processes include sales and order processing, purchasing tasks, inventory control and management, manufacturing and production control, shipping and receiving, accounts payable, and the like. Businesses continually strive to define, document, and streamline such processes in order to effectively compete.

Computer systems and associated software now provide tools with which businesses and other organizations can improve workflow. Software tools can be used to model business workflow processes or schedules and identify inefficiencies and possible improvements. In addition, where a process involves exchanging data between people, departments, plants, or even between separate companies, computer systems and networks can be used to implement such exchanges. These systems and software tools are further able to implement large-scale computations and other data or information processing which typically are associated with business related information. Automation of such information processing has led to many efficiency improvements in the modem business world; and workflow management includes effective management of information flow and control in an organization's business processes. Automation of workflow management is now allowing businesses and other organizations to further improve performance by executing workflow transactions in computer systems, including global computer networks, such as the Internet.

Workflow applications can be of particular utility in processing business transactions between different companies. In a typical application, two companies having a buyer-seller relationship can desire to automate generation and processing of purchase orders, product shipments, billing, and collections. Automating such processes can result in significant efficiency improvements. However, this inter-company application of workflow technology requires cooperation of the companies and proper interfacing of the individual company's existing computer systems.

There has been a strong movement to take advantage of advances in information technology within enterprises to speed up business processes and decision making, and to offer responsive service to customers and partners. Such nimbleness is in fact now the hallmark of a competitive “zero latency” business enterprise.

Business process automation within an enterprise requires workflow systems that allow the definition, execution, and monitoring of automated long-running processes to coordinate the activities of multiple business applications. Process definition in this context does not usually attempt to separate implementation from abstract process description. The situation is very different when processes span business boundaries, since the independent parties involved in the process do not share application and workflow implementation technologies and will normally not allow external control over the use of their backend applications. Conventional cross-enterprise process automation requires formalized business protocols focusing on their externally visible “wire” behavior.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention relates generally to business process system(s), and more particularly system(s) employing a correlation set to facilitate business process(es). The present invention provides for a declarative correlation mechanism that supports complex patterns of correlation via the correlation set. Correlated exchange(s) can nest and overlap, and message(s) can, in general, carry several sets of correlation tokens (e.g., multiple correlation set(s)).

In accordance with an aspect of the present invention, a system for sending message(s) having a data retrieval component, a service component, a schema store, a process definition store and a process data store is provided. The system facilitates description of business process(es) and their constituent message(s). The system can store information associated with business process(es) (e.g., involving business partner(s) and/or completed business process(es)). The system retrieves a schema associated with a type of business process and identifies a message type associated with the schema and a business process. An activation message is created based on in the message type and the business process. The activation message uniquely defines correlation value(s) for correlation field(s) of a correlation set for subsequent message(s) in a correlation group (e.g., associated with the business process). The system can also store instance data associated with the initiated business process (e.g., along with other instances of business process data).

The data retrieval component retrieves a schema (e.g., associated with one or more message type(s)) for the business process. For example, the schema can be stored in a schema store.

The schema store can include a plurality of schema with each having one or more message type(s). The schema store can be searched by the data retrieval component based, at least in part, upon a type of business process (e.g., purchase from vendor A or sale to customer B). Typically, the schema is known by the parties to the business process (e.g., set forth at “design-time”). The process definition store can store information associated with business process(es), for example, sequencing and/or scoping of correlations sets.

After locating the schema associated with the business process, the data retrieval component ascertains the appropriate message type associated with the schema and the business process. The data retrieval component provides information associated with the schema and/or the message type to the service component. The service component can populate and send a message based, at least in part, upon the schema and/or the message type.

For initiation of a business process, the first message will generally be an activation message. The activation message uniquely defines correlation value(s) for correlation field(s) of a correlation set for remaining message(s) in a correlation group (e.g., associated with the business process).

Thus, the activation message initializes the value(s) of the correlation field(s) (e.g., properties) in a correlation set. Those values are then generally fixed as constants for the lifetime of the correlation set. If the first message in the set is received by a business process, the process is said to be a follower in that another entity (partner process) has set the value(s) of the correlation set. In this case the message is either an activation message (e.g., created a new instance of the receiving process) or the message carried an additional correlation set that was used to route the message to an existing instance. If the first message in the set is sent by the business process then the process is the initiator of the set in the sense that it sets the values of the properties in the set.

The service component can further create instance data for storing state information associated with the business process. The service component can store the instance data in a process data store.

Subsequent message(s) associated with the business process will have substantially the same values for the correlation set as the activation message. Accordingly, the subsequent message(s) can be routed to the instance data (e.g., stored in the process data store).

The service component populates the correlation field(s) in the message with value(s), for example, from process data store (e.g., based on user input). The service component further sends the message to a port (e.g., of a business process system) as defined in the schema. “Port” can be a number and/or a description of address, protocol, and any other information to make a connection to the business process system.

Another aspect of the present invention provides for a system for receiving message(s) having a message identification component and a message routing component. Optionally, the system can include a schema store and/or a process data store.

The system facilitates business process(es) and their constituent message(s). The system can store information associated with business process(es) (e.g., involving business partner(s) and/or completed business process(es)). Based, at least in part, upon receipt of a message, the system retrieves a schema associated with a type of business process and identifies a correlation set associated with the message. The system can search the process data store to determine whether instance data corresponding to the business process exists based, at least in part, upon the correlation set. If instance data does not exit, the system can create instance data corresponding to the business process based, at least in part, upon the correlation set.

The message identification component receives a message (e.g., via a port). The message identification component can parse the message, for example, into an XML document object model (DOM). The message includes information associated with a schema and a message type to which the message belongs. Based, at least in part, upon this information, the message identification component can retrieve information associated with the schema (e.g., from the schema store) in order to determine correlation value(s) that are described in the message type—a correlation set.

The schema store can store information associated with schema(s). For example, a schema can include a format of a message type and/or correlation field(s). The process definition store can store information associated with business process(es), for example, sequencing and/or scoping of correlations sets.

The message routing component then identifies the correlation set associated with the message and uses the correlation set to determine if instance data corresponding to those values exists (e.g., in the process data store). If the instance data does not exist, the message routing component creates instance data associated with the message based, at least in part, upon the correlation set. The instance data can be stored in the process data store.

Based, at least in part, upon the correlation set, the message routing component then routes the message to the instance data associated with the business process for further processing, for example, checking inventory, notifying order systems and/or checking shipping schedules. This processing may cause other message(s) to be sent out in response to the message received. These other message(s) generally contain substantially the same correlation set to allow it to be routed to the instance data that contains the information for this business process (e.g., in a separate business process system). Note that this places very little constraint on the order or contents of the message(s). The message type in the schema identifies which field(s) have correlation value(s)—the correlation set. Accordingly, the correlation value(s) can occur in any order and can be interspersed throughout the message(s). The correlation value(s) need not be in substantially the same order as in the received message.

The instance data stores state information associated with the business process (e.g., business process open, ordered and/or filled). The process data store stores information associated with instance data.

Correlation set(s) can be recycled during the lifetime of a single process instance, for instance in a loop construct. The lifetime of a correlation set, specifically, of the set of correlation value(s) for the correlation field(s), is the same as the lifetime of the correlation set declaration, which follows the standard lexical scoping rules used for nested declaration scopes in programming languages, for example, Algol and/or Pascal.

Yet another aspect of the present invention provides for business process system(s) having two or more parties. The business process system(s) exchange message(s) associated with business process(es). A correlation set uniquely identifies a particular business process. The business process system(s) can facilitate, for example, chaining of business processes (e.g., correlation sets “chained” together).

The correlation framework facilitates business processes in which multiple messages carrying a common set of correlation values can arrive in random order and may need to be received by a single instance of the business process. The first of these messages to arrive acts as an activation message and the causes a new instance of the process (e.g., instance data) to be created with the later arriving ones received by the already created instance.

In one example, a new instance of a business process is permitted to be created by a large number of security principals but once created, further interaction with the specific instance is permitted only to the creator. The correlation feature of the present invention facilitates instance level authorization, for example, by using the identity of the creator as a correlation property and defining a correlation set including this property. Thus, by associating this correlation set with substantially all inbound message(s) that are sent by the creator to the exclusion of substantially all others, instance level authorization is facilitated.

Other aspects of the present invention provide methods for sending a message and methods for receiving a message. Further provided are a computer readable medium having computer usable instructions for a system for sending a message and a computer readable medium having computer usable instructions for a system for receiving a message. Also provided is a data packet adapted to be transmitted between two or more computer components facilitating a business process, the data packet comprising a correlation set comprising at least one correlation value, the correlation set uniquely identifying the business process.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a block diagram of a system for sending message(s) in accordance with an aspect of the present invention.

FIG. 2 is an exemplary message in accordance with an aspect of the present invention.

FIG. 3 is a block diagram of a system for receiving message(s) in accordance with an aspect of the present invention.

FIG. 4 is a block diagram of a business process system in accordance with an aspect of the present invention.

FIG. 5 is a block diagram of a business process system in accordance with an aspect of the present invention.

FIG. 6 is a block diagram of a business process system in accordance with an aspect of the present invention.

FIG. 7 is a flow chart illustrating a methodology for generating an activation message in accordance with an aspect of the present invention.

FIG. 8 is a flow chart illustrating a methodology for receiving a message in accordance with an aspect of the present invention.

FIG. 9 is a schematic block diagram of an exemplary operating environment for a system configured in accordance with the present invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the term “computer component” is intended to refer to a computer-related entity, either hardware, a combination of hardware and software, software, or software in execution. For example, a computer component may be, but is not limited to being, a process running on a processor, a processor, an object, an executable, a thread of execution, a program, and/or a computer. By way of illustration, both an application running on a server and the server can be a computer component. One or more computer components may reside within a process and/or thread of execution and a component may be localized on one computer and/or distributed between two or more computers.

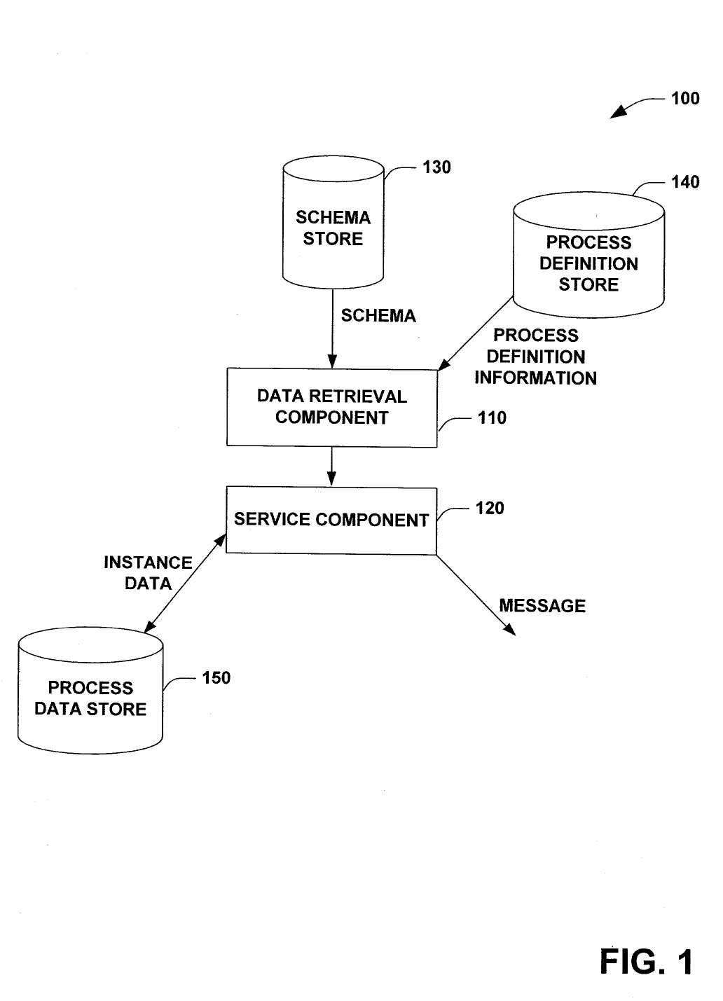

Referring to FIG. 1, a system 100 for sending message(s) in accordance with an aspect of the present invention is illustrated. The system 100 includes a data retrieval component 110 and a service component 120.

The system 100 facilitates description of business process(es) and their constituent message(s). The system 100 can store information associated with business process(es) (e.g., involving business partner(s) and/or completed business process(es)). The system 100 retrieves a schema associated with a type of business process and identifies a message type associated with the schema and a business process. An activation message is created based on in the message type and the business process. The activation message uniquely defines correlation value(s) for correlation field(s) of a correlation set for subsequent message(s) in a correlation group (e.g., associated with the business process). The system 100 can also store instance data associated with the initiated business process (e.g., along with other instances of business process data) in the process data store 150.

The data retrieval component 110 retrieves a schema (e.g., associated with one or more message type(s)) for the business process. For example, the schema can be stored in a schema store 130.

In one example, the schema store 130 comprises one schema. In another example, the schema store 130 includes a plurality of schema with each having one or more message type(s). The schema store 130 can be searched by the data retrieval component 110 based, at least in part, upon a type of business process (e.g., purchase from vendor A or sale to customer B). For example, information associated with the type of business process can be received and/or retrieved from a process definition store 140. Typically, the schema is known by the parties to the business process (e.g., set forth at “design-time”).

Before entities (e.g., businesses, firms, or organizations) can communicate, they generally agree on what type of document(s) they will be exchanging and how the document(s) will be exchanged. To facilitate communication, the entities agree on schema(s). The schema(s) set forth a format of message type(s) that will be exchanged and the correlation field(s) in those messages. It also allows for correlation group(s) and scopes of correlation(s) to be defined. Because correlation field(s) are identified separately, they can generally appear anywhere in a message. For example, if a company A has been using one document and wants to do business with a new company B that is unfamiliar with the document, company B can review a schema to identify the unique field(s) in the document and use those to route the document. How the data is used once it is routed is application dependent.

The process definition store 140 can store information associated with declaration of correlation set(s) and/or the sequence of message(s). For example, the process definition store 140 can facilitate complex message interaction(s), with loop(s), exception(s), and other control pattern(s). In one example, this can allow instance data to be cleaned-up when a business process is over. The activation message, which can be flagged in the schema, allows the instance data to be created (e.g., and stored in a process data store) whenever an activation message is received. The sender of the activation message creates instance data based on the initiator (e.g., external). The schema can also identify behavior(s) that describe a sequence of message(s). Behavior(s) can correspond to one or many business processes.

Correlation can be based on abstract named properties, for example, “purchase order number” or “session ID”. The correlation framework assumes a global space of uniquely named properties that can then be mapped in different ways to different message type(s). For example, the properties can have unique qualified names (e.g., Qnames in the sense of XML Namespaces).

After locating the schema associated with the business process, the data retrieval component 110 ascertains the appropriate message type associated with the schema and the business process. The data retrieval component 110 provides information associated with the schema and/or the message type to the service component 120. A business process corresponds to a schema that contains message type(s). The service component 120 can populate and send a message based, at least in part, upon the schema and/or the message type.

For initiation of a business process, the first message will generally be an activation message. The activation message uniquely defines correlation value(s) for correlation field(s) of a correlation set for remaining message(s) in a correlation group (e.g., associated with the business process). Alternatively, a business process can be instantiated based upon receipt of a message having a correlation set not associated with instantiated business process(es).

Thus, the activation message initializes the value(s) of the correlation field(s) (e.g., properties) in a correlation set. Those values are then generally fixed as constants for the lifetime of the correlation set. If the first message in the set is received by a business process, the process is said to be a follower in that another entity (partner process) has set the value(s) of the correlation set. In this case the message is either an activation message (e.g., created a new instance of the receiving process) or the message carried an additional correlation set that was used to route the message to an existing instance. If the first message in the set is sent by the business process then the process is the initiator of the set in the sense that it sets the values of the properties in the set.

For example, the first message of a business process can be identified explicitly as an activation message in the schema with a field named “activation” set to “true.” For example, the activation message can be transmitted using TCP/IP, UDP, SOAP, HTTP, EDI and/or SMTP. In one example, the message is based, at least in part, upon XML, SGML and/or HTML.

Those skilled in the art will appreciate that the correlation value(s) can be carried in message(s) in a variety of ways in accordance with the present invention. For example, the correlation value(s) can be carried in protocol envelope(s), header(s) and/or in application data. For example, XPath annotations in XML schema can be used to define properties relative to schema, and similar annotations for WSDL message type definitions independent of the schemas used in the definitions of those message types.

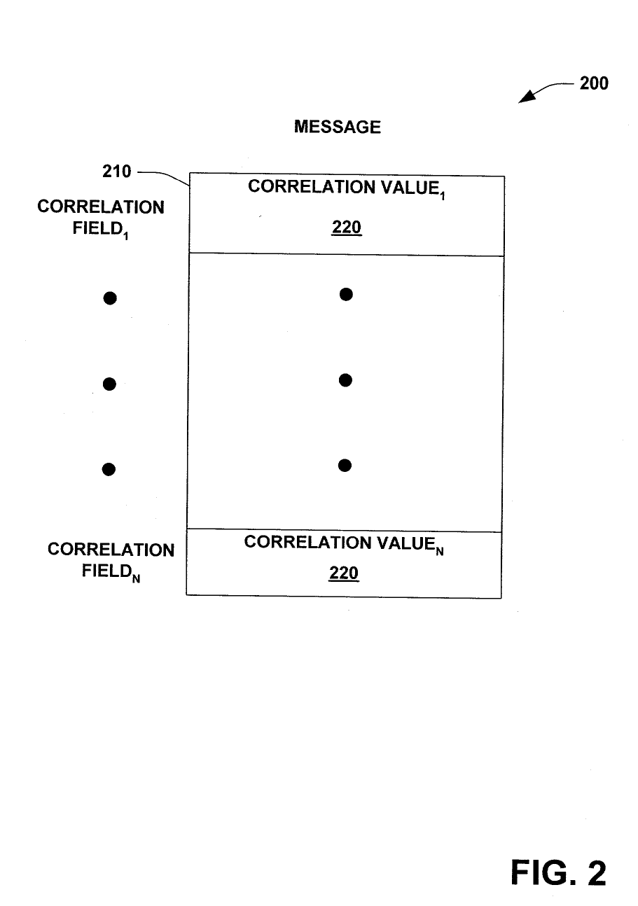

Turning briefly to FIG. 2, correlation field(s) 210 identify field(s) in message(s) 200. They are generally defined by a message type within a particular schema. Correlation value(s) 220 are the value(s) associated with correlation field(s) 210 (e.g., value(s) found in correlation field(s) within a message). The correlation value(s) 220 uniquely identify a correlation group. It is to be appreciated that, while the correlation field(s) 210 are depicted contiguously and sequentially in FIG. 2, the correlation field(s) can be located at various location(s) in the message 200 in accordance with an aspect of the present invention.

Correlation set(s) are set(s) of identifiers. Multiple correlation sets can be found in a message; however, generally one set identifies to which instance data the message should be routed. In the instance in which there are multiple correlation sets, as in the case of “chaining” of business process(es) as described below, they generally route to the same instance data.

A correlation group is a group of messages associated with the same instance data and are part of the same business process. In certain instances, a business process can contain multiple correlation groups.

Referring back to FIG. 1, the service component 120 can further create instance data for storing state information associated with the business process. The service component 120 can store the instance data in a process data store 150. The process data store 150 can store instance data associated with one or more instantiated business process(es).

Subsequent message(s) associated with the business process will have substantially the same values for the correlation set as the activation message. Accordingly, the subsequent message(s) can be routed to the instance data (e.g., stored in the process data store 150). For example the subsequent message(s) can be transmitted using TCP/IP, UDP, SOAP, HTTP, EDI and/or SMTP.

Generally, the value(s) of the correlation set do not change within a correlation group, although more than one activation message can be sent with the same correlation set, allowing two different correlation groups with different values for the same correlation set to be sent in a business process. Although a correlation identifier can have substantially the same value in two different correlation groups, when taken together, values in correlation sets uniquely identify a correlation group. Otherwise, routing to a particular instance data would have to rely on another mechanism in addition to correlation identifiers.

The service component 120 populates the correlation field(s) in the message with value(s), for example, from business process data store 140 (e.g., based on user input). The service component 120 further sends the message to a port (e.g., of a business process system) (not shown) as defined in the schema. “Port” can be a number and/or a description of address, protocol, and any other information to make a connection to the business process system.

Those skilled in the art will appreciate that the system 100 can be employed, for example, as part of an automated purchasing system, an order processing system, an inventory control system and/or an enterprise resource planning system.

While FIG. 1 is a block diagram illustrating components for the system 100, it is to be appreciated that the data retrieval component 110 and/or the service component 120 can be implemented as one or more computer components, as that term is defined herein. Thus, it is to be appreciated that computer executable components operable to implement the system 100, the data retrieval component 110 and/or the service component 120 can be stored on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the present invention.

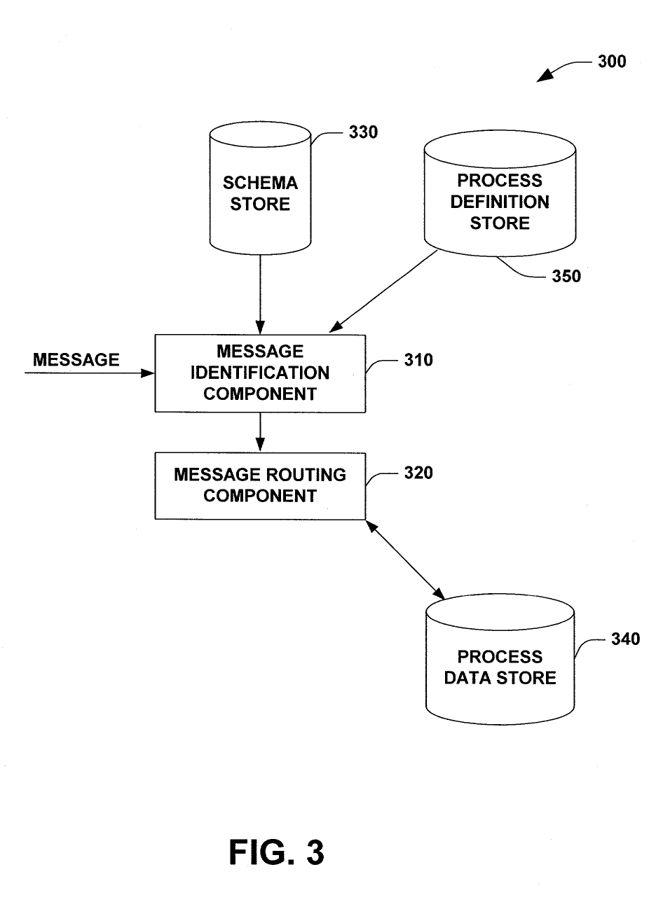

Turning to FIG. 3, a system 300 for receiving message(s) in accordance with an aspect of the present invention is illustrated. The system 300 includes a message identification component 310 and a message routing component 320. Optionally, the system 300 can include a schema store 330, a process data store 340 and/or a process definition store 350.

The system 300 facilitates processing of business process(es) and their constituent message(s). The system 300 can store information associated with business process(es) (e.g., involving business partner(s) and/or completed business process(es)). Based, at least in part, upon receipt of a message, the system 300 retrieves a schema associated with a type of business process and identifies a correlation set associated with the message. The system 300 can search the process data store 340 to determine whether instance data corresponding to the business process exists based, at least in part, upon the correlation set. If instance data does not exist, the system 300 can create instance data corresponding to the business process based, at least in part, upon the correlation set (e.g., instantiate the business process).

The message identification component 310 receives a message (e.g., via a port). The message can be based, for example, on XML, SGML and/or HTML. For example, the message can be transmitted using TCP/IP, UDP, SOAP, HTTP, EDI and/or SMTP.

The message identification component 310 can parse the message, for example, into an XML document object model (DOM). The message includes information associated with a schema and a message type to which the message belongs. Based, at least in part, upon this information, the message identification component 310 can retrieve information associated with the schema (e.g., from the schema store 330) in order to determine correlation value(s) that are described in the message type—a correlation set.

The schema store 330 can store information associated with schema(s). For example, a schema can include a format of a message type and/or correlation field(s) for particular message type(s).

The process definition store 350 can store information associated with one or more business process(es). For example, the process definition store 350 can store information associated with declaration of correlation set(s) and/or a sequence of message(s) to be exchanged.

The message routing component 320 then identifies the correlation set associated with the message and uses the correlation set to determine if instance data corresponding to those values exists (e.g., in the process data store 340). If the instance data does not exist, the message routing component 320 creates instance data associated with the message based, at least in part, upon the correlation set (e.g., instantiates a business process). The instance data can be stored in the process data store 340.

Based, at least in part, upon the correlation set, the message routing component 320 then routes the message to the instance data associated with the business process for further processing, for example, checking inventory, notifying order systems and/or checking shipping schedules. This processing may cause other message(s) to be sent out in response to the message received. These other message(s) generally contain substantially the same correlation set to allow it to be routed to the instance data that contains the information for the business process (e.g., in a separate business process system). Note that this places very little constraint on the order or contents of the message(s). The message type in the schema identifies which field(s) have correlation value(s)—the correlation set. Accordingly, the correlation value(s) can occur in any order and can be interspersed throughout the message(s). The correlation value(s) need not be in substantially the same order as in the received message.

The instance data stores state information associated with the business process (e.g., business process open, ordered and/or filled). The process data store 340 stores information associated with instance data of one or more business process(es).

In one example, correlation set enforcement facilitates ensuring that message(s) associated with a correlation set carry the correct correlation value(s) defined by the correlation set. Except for message(s) that initialize the correlation value(s) (e.g., activation message(s)), as described above, other message(s) carry the predetermined correlation value(s)—the correlation set. In the case of message(s) sent from a business process this involves either verifying and/or setting these correlation value(s). In the case of messages received, the actual values can be used to dynamically create routing rules to route the messages to the correct business process instance.

In another example, correlation set(s) can be recycled during the lifetime of a single process instance, for instance in a loop construct. The lifetime of a correlation set, specifically, of the set of correlation value(s) for the correlation field(s), is the same as the lifetime of the correlation set declaration, which follows the standard lexical scoping rules used for nested declaration scopes in programming languages, for example, Algol and/or Pascal.

It is to be appreciated that the message identification component 310 and/or the message routing component 320 can be computer components, as that term is defined herein.

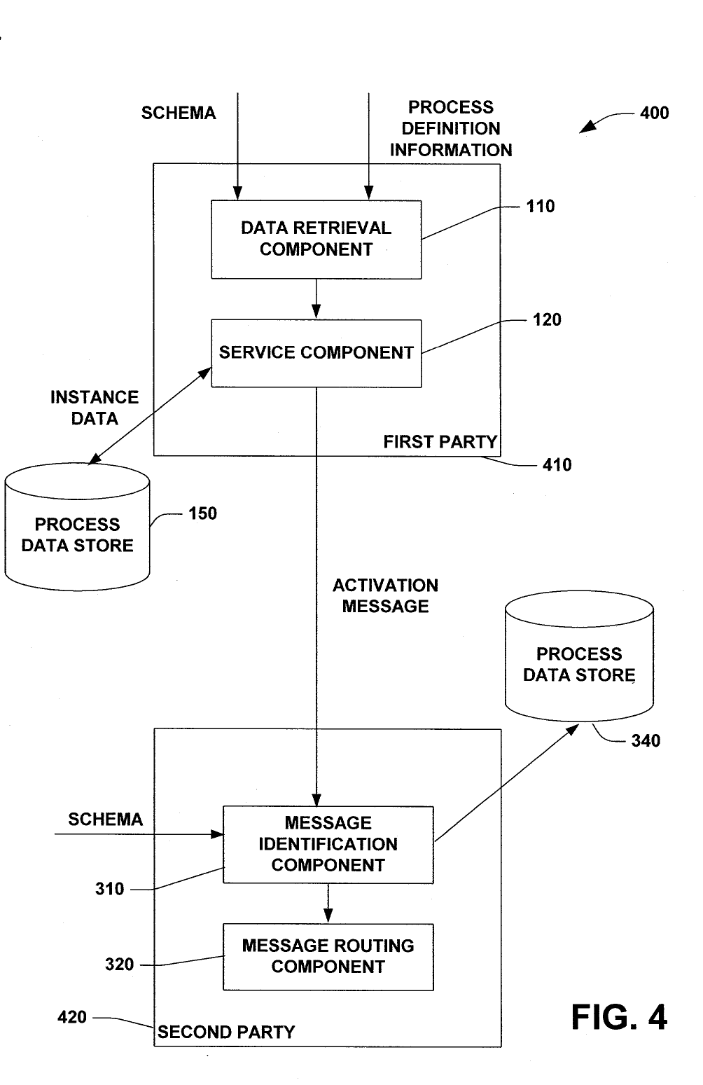

Turning to FIG. 4, a business process system 400 in accordance with an aspect of the present invention is illustrated. The system 400 includes a first party 410 and a second party 420.

The first party 410 includes a data retrieval component 110 and a service component 120. As described previously, the first party 410 initiates a business process by generating an activation message having a correlation set that uniquely identifies the business process. The first party 410 can store instance data in a process data store 150.

The second party 420 includes a message identification component 310 and a message routing component 320. As described previously, the second party 420 can receive the activation message from the first party 410. After receiving the activation message, the second party 420 can create instance data, for example, in a process data store 340.

It is to be appreciated that the first party 410 and/or the second party 420 can be computer components, as that term is defined herein.

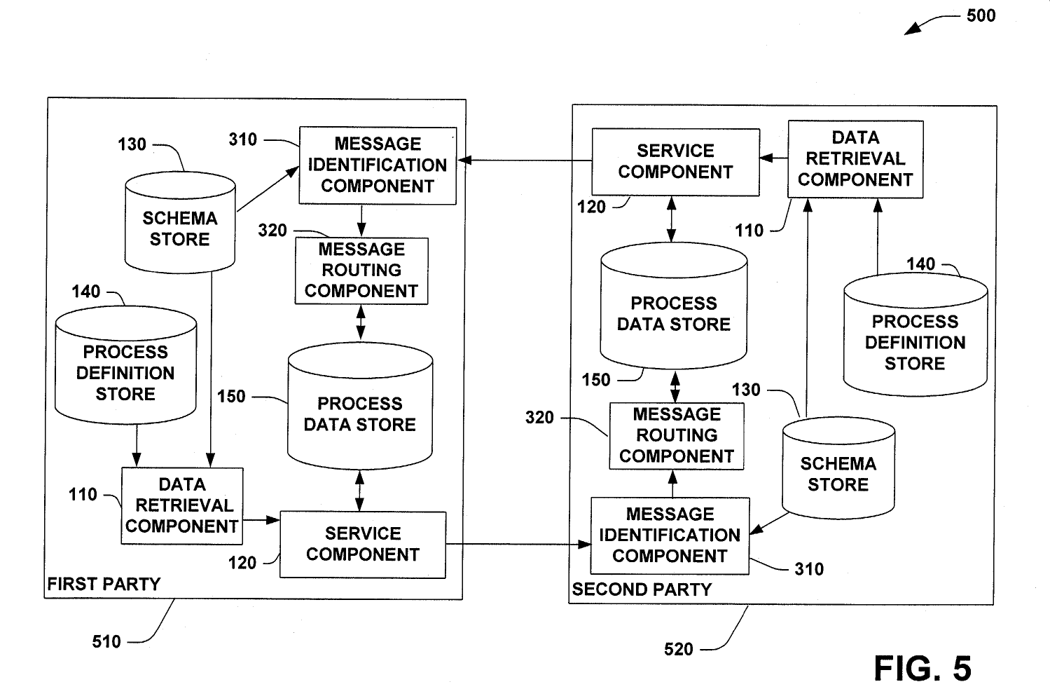

Referring to FIG. 5, a business process system 500 in accordance with an aspect of the present invention is illustrated. The system 500 includes a first party 510 and a second party 520.

The first party 510 and the second party each includes a data retrieval component 110, a service component 120, a schema store 130, a process definition store 140, a process data store 150, a message identification component 310 and a message routing component 320. The message identification component 310 retrieves information regarding schema(s) from the schema store 130; the message routing component 320 retrieves and/or stores instance data in the process data store 150.

Thus, the first party 510 and the second party 520 can conduct business process(es) with activation message(s) causing the creation of instance data by the service component 120 of the sending party and by the message routing component 320 of the receiving party. The activation message includes a correlation set that uniquely identifies the business process. Subsequent message(s) of a particular business process include the correlation set uniquely identified via the activation message associated with the particular business process.

It is to be appreciated that the first party 510 and/or the second party 520 can be computer components, as that term is defined herein.

In one example, often, one party wants to identify a business process with one identifier and another wants to use a different identifier. For example, a buyer may use a purchase order number (PO#) to identify a business process and the seller may use an order number to identify the same business process. Also, there may be multiple parties involved, for example there may be a shipper in addition to a buyer and seller. Different correlation sets can be used in the same business process via chaining.

To chain two correlation sets together, one party in the business process sends a message that contains multiple correlation sets, allowing them to be chained together. This message will be part of an ongoing correlation group for one correlation set and it will be the activation message for another correlation group. One way of accomplishing this is to have the lookup for both correlation sets return the same instance data. Multiple correlation sets can be chained together—they need not be chained to the original message (“chained” business processes).

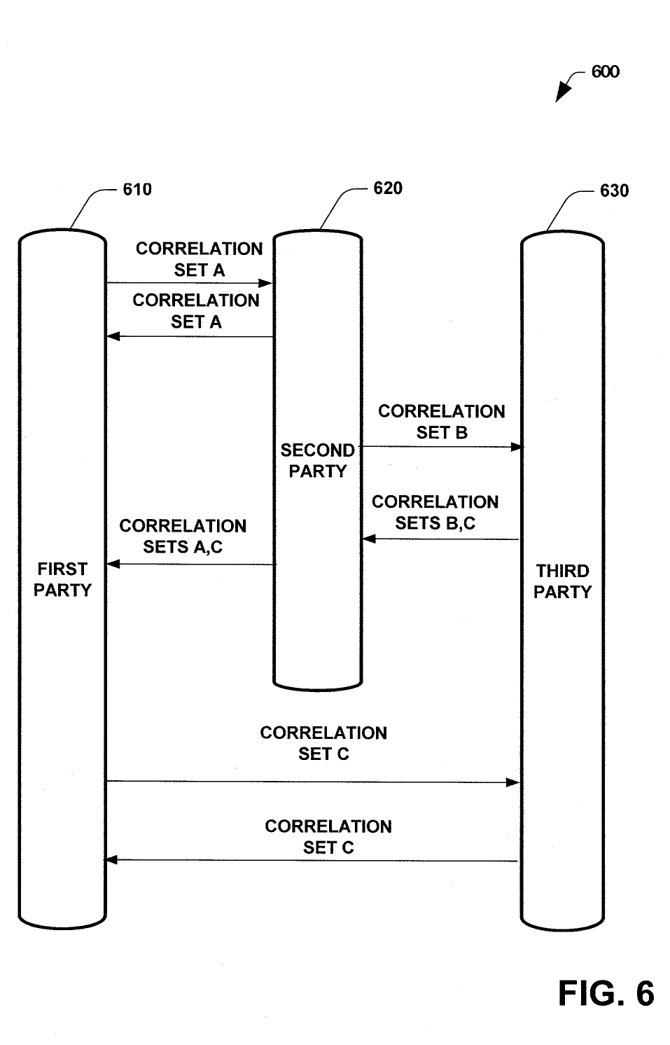

Referring to FIG. 6, a business process system 600 in accordance with an aspect of the present invention is illustrated. The system 600 includes a first party 610, a second party 620 and a third party 630.

While FIG. 6 depicts chaining of business processes involving three parties, it is to be appreciated that present invention is not intended to be limited to chaining of business processes involving three parties. As such, any number of parties can be involved in chaining business processes in accordance an aspect of the present invention.

The first party 610 (e.g., a buyer) sends an activation message with a first correlation set (correlation set A) (e.g., P.O.#) to the second party 620 (e.g., a seller). The second party 620 can send back to the first party 610 an acknowledgement message having the first correlation set (correlation set A).

The second party 620 can then send a message (e.g., shipping request) to the third party 630 (e.g., shipper) identified by a second correlation set (correlation set B) (e.g., seller's order number). This message can come from the same instance data and/or different instance data in the second party 620.

The third party 630 can then send back an acknowledge message having the second correlation set (correlation set B) and can act as an activation message for a third correlation set (correlation set C) (e.g., ship number). The second party 620 can then send a message to the first party 610 with the first correlation set (correlation set A) and the third correlation set (correlation set C). For example, if there are multiple shippers, this message can also contain a shipper identifier (e.g., a service and/or port). This message is an activation message as far as the first party 610 is concerned. If the first party 610 wishes to later query the third party 630 (e.g., for a delivery date), the first party 610 can send a message to the third party 630 with the third correlation set (correlation set C) and/or with the second correlation set (correlation set B). The third party 630 can then respond with a message with the same correlation set.

In one example, at some point the first party 610 can send out a confirmation number when goods are received and the business process is substantially completed. The second party 620 and/or the third party 630 can then clean up their instance data.

It is to be appreciated that the first party 610, the second party 620 and/or the third party 630 can be computer components, as that term is defined herein.

The correlation framework of the present invention facilitates business processes in which multiple messages carrying a common set of correlation values can arrive in random order and may need to be received by a single instance of the business process. The first of these messages to arrive acts as an activation message and causes a new instance of the process (e.g., instance data) to be created with the later arriving ones received by the already created instance.

In one example, a new instance of a business process is permitted to be created by a large number of security principals but once created, further interaction with the specific instance is permitted only to the creator. The correlation feature of the present invention facilitates instance level authorization, for example, by using the identity of the creator as a correlation property and defining a correlation set including this property. Thus, by associating this correlation set with substantially all inbound message(s) that are sent by the creator to the exclusion of substantially all others, instance level authorization is facilitated.

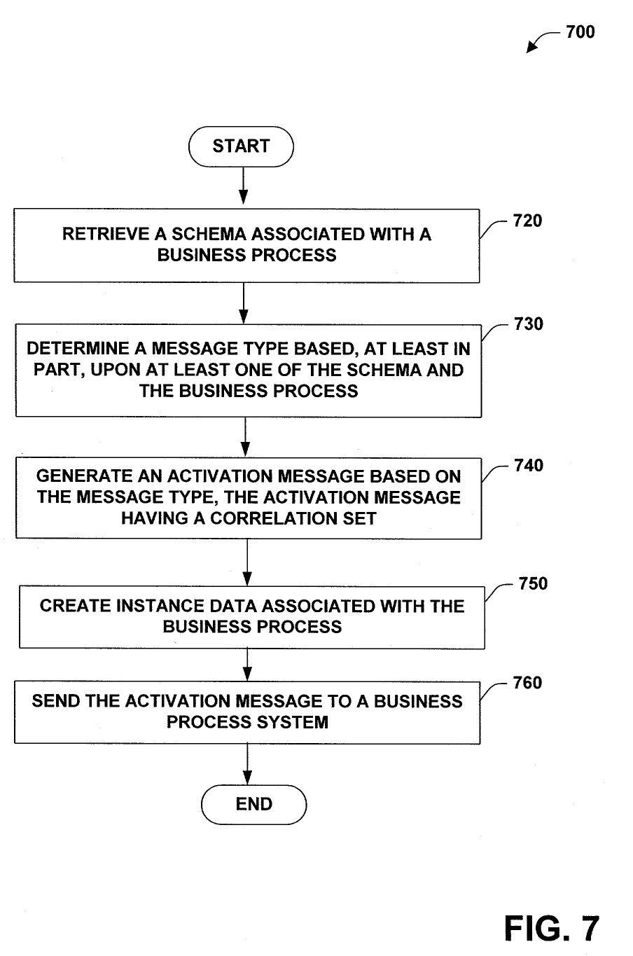

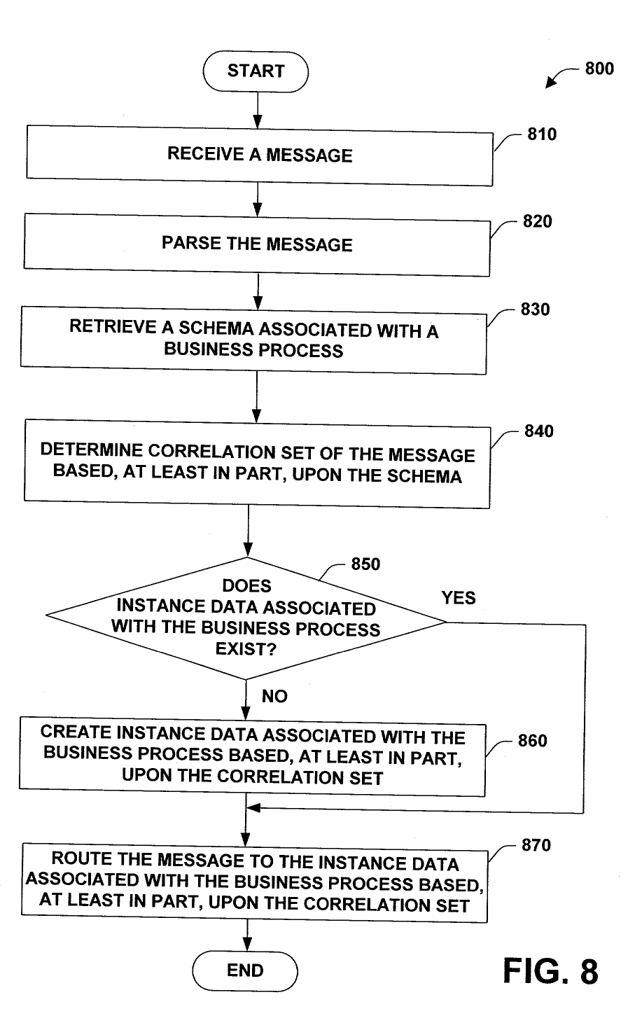

In view of the exemplary systems shown and described above, methodologies that may be implemented in accordance with the present invention will be better appreciated with reference to the flow charts of FIGS. 7 and 8. While, for purposes of simplicity of explanation, the methodologies are shown and described as a series of blocks, it is to be understood and appreciated that the present invention is not limited by the order of the blocks, as some blocks may, in accordance with the present invention, occur in different orders and/or concurrently with other blocks from that shown and described herein. Moreover, not all illustrated blocks may be required to implement the methodologies in accordance with the present invention.

The invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Turning to FIG. 7, a methodology 700 for sending an activation message in accordance with an aspect of the present invention is illustrated. At 720, a schema associated with the business process is retrieved (e.g., from a schema store). Next, at 730, a message type is determined based, at least in part, upon the schema and/or the business process. At 740, an activation message is generated based on the message type. The activation message includes a correlation set (e.g., uniquely identifying the business process).

At 750, instance data associated with the business process is created. For example, the instance data can be stored in a process data store that stores state information associated with the business process. At 760, the activation message is sent to a business process system.

Turning next to FIG. 8, a methodology 800 for receiving a message in accordance with an aspect of the present invention is illustrated. At 810, a message is received. At 820, the message is parsed. At 830, a schema associated with a business process is retrieved. Next, at 840, a correlation set of the message based, at least in part, upon the schema are determined.

At 850, a determination is made as to whether instance data associated with the business process exists. If the determination at 850 is NO, at 860, instance data associated with the business process is created (e.g., business process instantiated) based, at least in part, upon the correlation set and processing continues at 870. If the determination at 850 is YES, processing continues at 870.

At 870, the message is routed to the instanced data associated with the business process based, at least in part, upon the correlation set.

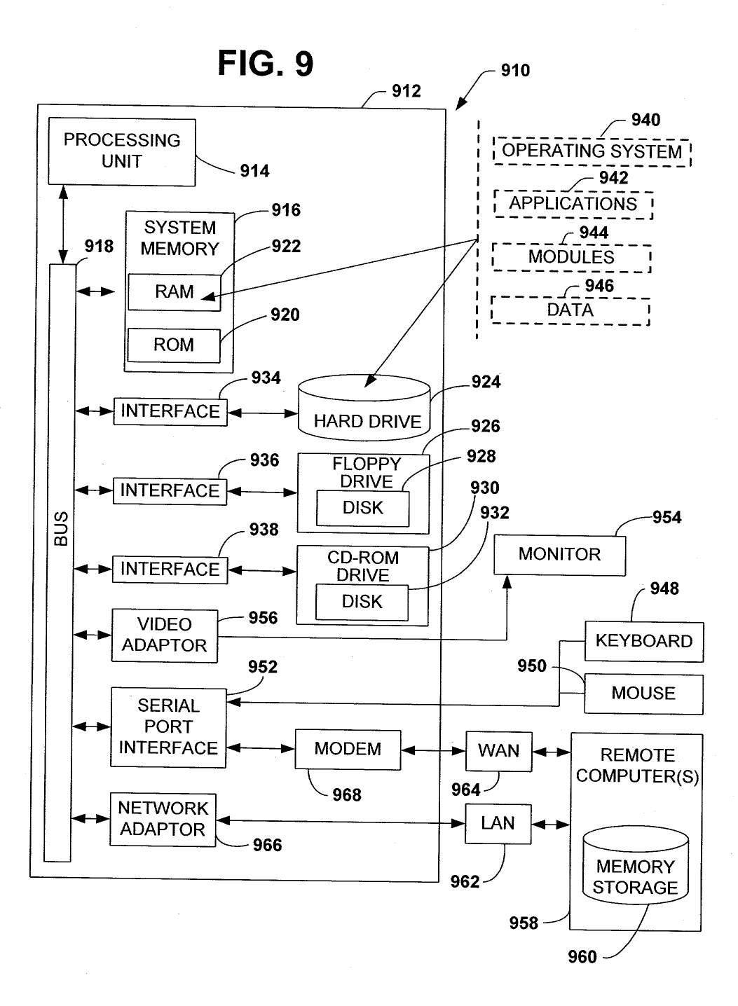

In order to provide additional context for various aspects of the present invention, FIG. 9 and the following discussion are intended to provide a brief, general description of a suitable operating environment 910 in which various aspects of the present invention may be implemented. While the invention is described in the general context of computer-executable instructions, such as program modules, executed by one or more computers or other devices, those skilled in the art will recognize that the invention can also be implemented in combination with other program modules and/or as a combination of hardware and software. Generally, however, program modules include routines, programs, objects, components, data structures, etc. that perform particular tasks or implement particular data types. The operating environment 910 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 9, an exemplary environment 910 for implementing various aspects of the invention includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/nonremovable, volatile/nonvolatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or nonremovable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the present invention can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 902.3, Token Ring/IEEE 902.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for sending a message, comprising:
a data retrieval component that retrieves a schema associated with a type of business process, identifies a message type associated with the schema and a business process, and, provides an output associated with at least one of the schema and the message type; and,
a service component that generates an activation message that uniquely defines a correlation value for a correlation field of a correlation set for a subsequent message in a correlation group associated with the business process based, at least in part, upon the output of the data retrieval component.

2. The system of claim 1, further comprising a schema store that stores at least one schema, the schema having at least one of a format of message types and correlation fields.

3. The system of claim 1, further comprising a process definition store that stores information associated with at least one of the type of business process, declaration of the correlation set and a sequence of messages to be exchanged.

4. The system of claim 1, the service component further creating instance data that stores state information associated with the business process.

5. The system of claim 4, further comprising a process data store that stores the instance data.

6. The system of claim 1, at least one of the activation message and the subsequent message being based, at least in part, upon at least one of XML, SGML and HTML.

7. The system of claim 1, at least one of the activation message and the subsequent message being transmitted using at least one of TCP/IP, UDP, SOAP, HTTP, EDI and SMTP.

8. An automated purchasing system employing the system of claim 1.

9. An order processing system employing the system of claim 1.

10. An inventory control system employing the system of claim 1.

11. An enterprise resource planning system employing the system of claim 1.

12. A system for receiving a message, comprising:
a message identification component that receives a message associated with a business process, identifies a schema and a message type associated with the message and provides an output having information associated with a correlation set associated with the message based, at least in part, upon the schema and a correlation value of the message; and,
a message routing component that routes the message to instance data associated with the business process based, at least in part, upon the output received from the message identification component.

13. The system of claim 12, the message routing component further creating instance data associated with the business process if it does not exist.

14. The system of claim 12, further comprising a schema store that stores at least one schema, the schema having at least one of a format of a message type and correlation fields.

15. The system of claim 12, the instance data storing state information associated with the business process.

16. The system of claim 12, further comprising a process data store that stores instance data.

17. The system of claim 12, the message being based, at least in part, upon at least one of XML, SGML and HTML.

18. The system of claim 12, the message being transmitted using at least one of TCP/IP, UDP, SOAP, HTTP, EDI and SMTP.

19. A business process system, comprising:
a first party having a data retrieval component that retrieves a schema associated with a type of business process, identifies a message type associated with the schema and a business process, and, provides an output associated with at least one of the schema and the message type, and, a service component that generates an activation message that uniquely defines a correlation value for a correlation field of a correlation set for a subsequent message in a correlation group associated with the business process based, at least in part, upon the output of the data retrieval component; and,
a second party having a message identification component that receives the activation message associated with a business process, identifies a schema and a message type associated with the activation message and provides an output having information associated with a correlation set associated with the message based, at least in part, upon the schema and a correlation value of the message, and, a message routing component that routes the activation message to instance data associated with the business process based, at least in part, upon the output received from the message identification component, the message routing component creating the instance data if it does not exist.

20. A business process system, comprising:
a first party having a data retrieval component, a service component, a schema store, a process definition store, a process data store, a message identification component and a message routing component; and,
a second party having a data retrieval component, a service component, a schema store, a process definition store, a process data store, a message identification component and a message routing component, the first party initiating a business process by an activation message that uniquely identifies a correlation set for the business process with a subsequent message having the correlation set.

21. A method for generating an activation message, comprising:
retrieving a schema associated with a business process;
determining a message type based, at least in part, upon at least one of the schema and the business process; and,
generating an activation message based on the message type, the activation message having a correlation set.

22. The method of claim 22, further comprising at least one of the following acts:
creating instance data associated with the business process; and,
sending the activation message to a business process system.

23. A method for receiving a message, comprising:
retrieving a schema associated with a business process;
determining a correlation set of a message based, at least in part, upon the schema;
creating instance data associated with the business process based, at least in part, upon the correlation set, if the instance data does not exist; and,
routing the message to the instance data associated with the business process based, at least in part, upon the correlation set.

24. The method of claim 23, further comprising at least one of the following acts:
receiving the message; and,
parsing the message.

25. A data packet adapted to be transmitted between two or more computer processes facilitating a business process, the data packet comprising:
a correlation set comprising at least one correlation value, the correlation set uniquely identifying the business process.

26. A computer readable medium having computer usable components for a system for sending a message, comprising:
a data retrieval component that retrieves a schema associated with a type of business process, identifies a message type associated with the schema and a business process, and, provides an output associated with at least one of the schema and the message type; and,
a service component that generates an activation message that uniquely defines a correlation value for a correlation field of a correlation set for a subsequent message in a correlation group associated with the business process based, at least in part, upon the output of the data retrieval component.

27. A computer readable medium having computer usable components for a system for receiving a message, comprising:
a message identification component that receives a message associated with a business process, identifies a schema and a message type associated with the message and provides an output having information associated with a correlation set associated with the message based, at least in part, upon the schema and a correlation value of the message; and,
a message routing component that routes the message to instance data associated with the business process based, at least in part, upon the output received from the message identification component.

28. A system for sending a message, comprising:
means for retrieving a schema associated with a type of business process;
means for identifying a message type associated with the schema and the business process; and,
means for generating an activation message that that uniquely defines a correlation value for a correlation field of a correlation set for a subsequent message in a correlation group associated with the business process based, at least in part, upon message type.

29. A system receiving a message, comprising:
means for receiving a message;
means for identifying a correlation set based, at least in part, upon a schema and a message type associated with the message; and,
means for routing the message to instance data associated with the business process based, at least in part, upon the correlation set.
